(19) United States
(12) Patent Application Publication
(10) Pub. No.: US 2014/0347967 A1
(43) Pub. Date: Nov. 27, 2014

(54) TESTING DEVICE AND TESTING METHOD FOR TESTING PERFORMANCE OF DISC PLAYER

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: PENG-FEI WANG, Shenzhen (CN); DONG-YAN LI, Shenzhen (CN); BING ZHOU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/287,413

(22) Filed: May 27, 2014

(30) Foreign Application Priority Data
May 27, 2013 (CN) 201310200290X

(51) Int. Cl. G11B 20/18

(52) U.S. Cl. CPC G11B 20/1816
USPC 369/53.11

(57) ABSTRACT

A testing device for testing performance parameters of a disc player which includes a display, and a storage. The storage at least one sector table associated with a disc in the disc player, each sector table recording sector information corresponding to a plurality of physical sectors of the disc, a testing command associated with each physical sector, and a reference value range of each of performance parameters of the disc player. The testing command corresponding to the physical sector of the disk is obtained to be executed by the disc player to obtain a value of each performance parameter of the disc player. The testing device determines whether the disc player is qualified or not according to the obtained value.

### FIELD

The present disclosure relates to testing technologies in relation to electronic devices, and more particularly to a testing device and a method capable of automatically obtaining performance parameters of a disc player to test the disc player according to the obtained performance parameters.

### BACKGROUND

During production of a disc player, performance parameters of the disc player are obtained to detect whether the disc player is qualified or not. In a typical test method, a number of different types of discs are used to test the disc player. Generally, when the disc player reads data from the different types of discs, the performance parameters of the disc player are different.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a testing device for obtaining performance parameters of a disc player to test the disc player.

FIG. 2 is a flowchart of an embodiment of a testing method for obtaining the performance parameters of the disc player to test the disc player using the testing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software commands, written in a programming language, for example, Java, C, or assembly. One or more software commands in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

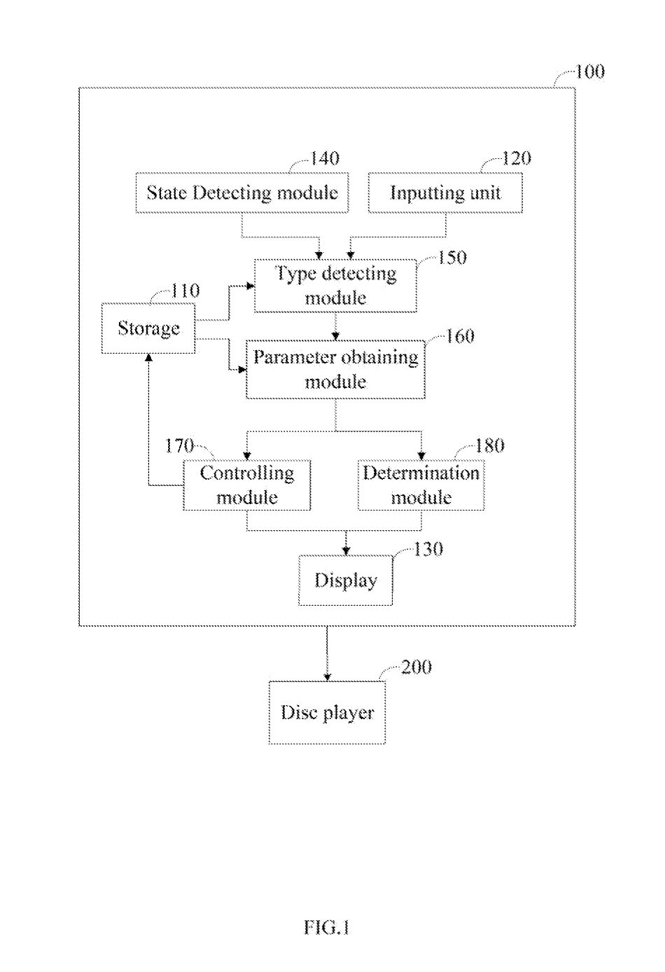

FIG. 1 illustrates a block diagram of an embodiment of a testing device 100. The testing device 100 is configured to obtain one or more performance parameters of a disc player 200, for testing the disc player 200. The testing device 100 can be an independent device or a component integrated in the disc player 200.

The testing device 100 includes a storage 110, an inputting unit 120, a display 130, a detecting module 140, a type state detecting module 150, a parameter obtaining module 160, a determination module 170, and a control unit 180.

The storage 110 stores at least one sector table associated with a disc in the disc player 200. Each sector table records sector information corresponding to a number of physical sectors of the disc, a testing command associated with each physical sector, and a reference value range of each of performance parameters of the disc player 200. The disc player 200 can execute the testing command. The reference value range of each performance parameter of the disc player 200 is associated with a type of disc. In the present embodiment, the disc can be a digital versatile disc (DVD), a compact disc (CD), or a blue-ray disc (BD).

The inputting unit 120 can be a keyboard, a mouse, a touch screen, a touch pad, or a barcode scanner, for example, to receive manual operations.

The display 30 displays can be a liquid crystal display (LCD), a light emitting diode (LED) display, or other like display devices.

The type detecting module 140 detects a type of disc when the disc is put into the disc player 200. In the present embodiment, the type detecting module 140 reads data of the disc to detect the type of disc. In the other embodiments, the type of disc can be manually input from the inputting unit 120, and the type detecting module 140 can obtain the type of disc from the inputting unit 120.

The state detecting module 150 detects whether the disc player 200 is in a to-be-tested state or not. In the present embodiment, the disc player 200 generates a to-be-tested command when the disc player 200 is prepared to be tested. If the to-be-tested command is detected, the disc player 200 is determined to be in the to-be-tested state.

When the disc player 200 is in the to-be-tested state, the parameter obtaining module 160 obtains each testing command from the sector table corresponding to the type of the disc, and controls the disc player 200 to execute each testing command for controlling the disc player 200 to read data of the corresponding sector according to the sector information. When each testing command is executed by the disc player 200, a value of each performance parameter of the disc player 200 can be obtained by the parameter obtaining module 160.

The control module 170 controls the display 130 to display the value of each performance parameter of the disc player 200, and controls the storage 110 to store the performance parameters with the corresponding type of the disc.

The determination module 180 determines whether the obtained value of each performance parameter of the disc player 200 is within the reference value range of the corresponding performance parameter. When the value of each performance parameter is within the reference value range, the control module 170 controls the display 130 to display a first prompt message indicating that the disc player 200 is qualified. When the value of at least one performance parameter is not within the reference value range, the control module 170 controls the display 130 to display a second prompt message indicating that the disc player 200 is not qualified.

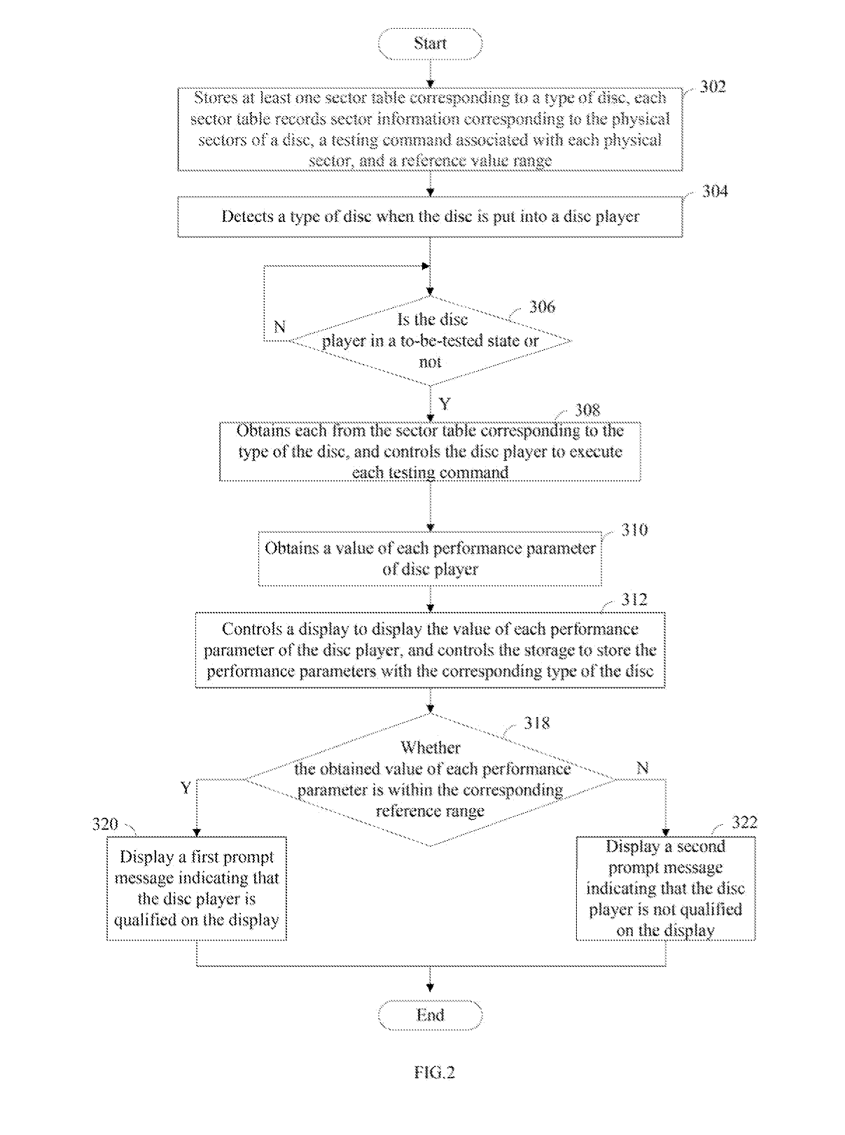

FIG. 2 illustrates a testing method implemented by a testing device to test a disc player. The testing device includes a storage, an inputting unit, a display, a detecting module, a type state detecting module, a parameter obtaining module, a determination module, and a control unit Depending on the embodiment, additional steps may be added, others removed, and the ordering of the steps may be changed.

In block 302, the storage stores at least one sector table associated with a disc in the disc player. Each sector table records sector information corresponding to a number of physical sectors of the disc, a testing command associated with each physical sector, and a reference value range of each of performance parameters of the disc player. The disc player can execute the testing command. The reference value range of each performance parameter of the disc player is associated with a type of disc.

In block 304, the type detecting module detects a type of disc when the disc is put into the disc player. In the present embodiment, the type detecting module reads data of the disc in order to detect the type of disc. In the other embodiments, the type of disc can be manually input from the inputting unit, and the type detecting module can obtain the type of disc from the inputting unit.

In block 306, the state detecting module detects whether the disc player is in a to-be-tested state or not. In present embodiment, the disc player generates a to-be-tested command when the disc player 200 is prepared to be tested. If the to-be-tested command is detected, the disc player is determined to be in the to-be-tested state, block 308 is implemented. If the to-be-tested command is not detected, the state detecting module repeats the to-be-tested command.

In block 308, the parameter obtaining module obtains each from the sector table corresponding to the type of the disc, and controls the disc player to execute each testing command for controlling the disc player to read data of the corresponding sector according to the sector information.

In block 310, the parameter obtaining module obtains a value of each performance parameter of disc player.

In block 312, the control module controls the display to display the value of each performance parameter of the disc player, and controls the storage to store the performance parameters with the corresponding type of the disc.

In block 314, the determination module determines whether the obtained value of each performance parameter of the disc player is within the reference value range of the corresponding performance parameter. When the value of each performance parameter is within the reference value range of the corresponding performance parameter, block 316 is implemented. When the value of each performance parameter is not within the reference value range of the corresponding performance, block 318 is implemented.

In block 316, a first prompt message indicating that the disc player is qualified is displayed on the display

In block 318, a second prompt message indicating that the disc player is not qualified is displayed on the display.

Although information as to, and advantages of, the present embodiments have been set forth in the foregoing description, together with details of the structures and functions of the present embodiments, the disclosure is illustrative only; and changes may be made in detail, including in the matters of shape, size, and arrangement of parts within the principles of the present embodiments to the full extent indicated by the broad general meaning of the terms in which the appended claims are expressed.

What is claimed is:

1. A device for testing performance parameters of a disc player, the device comprising:
a display;
a storage unit configured to store at least one sector table associated with a disc in the disc player, each sector table recording sector information corresponding to a plurality of physical sectors of the disc, a testing command associated with each physical sector, and a reference value range of each of performance parameters of the disc player;
a parameter obtaining module configured to obtain each testing command from the sector table and control the disc player to execute each testing command for controlling the disc player to read data of the corresponding sector according to the sector information, and obtain a value of each performance parameter of the disc player when each testing command is executed by the disc player;
a determination module configured to determine whether the disc player is qualified or not by determining whether the obtained value of each performance parameter of the disc player is within the reference value range of the corresponding performance parameter; and
a controlling module configured to cause the display to display a message indicating whether or not the disc player is qualified.

2. The testing device as claimed in claim 1, wherein a type of the disc is selectable from a plurality of predetermined types, each of the predetermined types corresponding to a different sector table, the testing device further comprises a type detecting module for detecting the type of the disc, and the parameter obtaining module obtains each testing command from the sector table corresponding to the detected type of the disc.

3. The testing device as claimed in claim 1, wherein the sector information comprises a physical sector number of the physical sector.

4. The testing device as claimed in claim 1, wherein when the value of each performance parameter is within the reference value range of the corresponding performance parameter, the determination module is further used for controlling the display to display a first prompt message indicating that the display is qualified.

5. The testing device as claimed in claim 1, when the value of at least one performance parameter is not within the reference value range of the corresponding performance parameter, the determination module is further used for controlling the display to display a second prompt message indicating that the display is not qualified.

6. A testing method for testing performance parameters of a disc player using a testing device, the testing method comprising:
storing at least one sector table associated with a disc in the disc player, each sector table recording sector information corresponding to a plurality of physical sectors of the disc, a testing command associated with each physical sector, and a reference value range of each of performance parameters of the disc player;
obtaining each testing command from the sector table and controlling the disc player to execute each testing command for controlling the disc player to read data of the corresponding sector according to the sector information;
obtaining a value of each performance parameter of the disc player when each testing command is executed by the disc player;
determining whether the disc player is qualified or not by determining whether the obtained value of each performance parameter of the disc player is within the reference value range of the corresponding performance parameter; and
displaying a message indicating whether or not the disc player is qualified via a display of the testing device.

7. The testing method as claimed in claim 6, wherein a type of the disc is selectable from a plurality of predetermined types, each of the predetermined types corresponding to a different sector table, the testing method further comprising:
detecting the type of the disc;
obtaining each testing command from the sector table corresponding to the detected type of the disc.

8. The testing method as claimed in claim 6, wherein the sector information is a physical sector number of the physical sector.

9. The testing method as claimed in claim 6, wherein when the value of each performance parameter is within the reference value range of the corresponding performance parameter, a first prompt message indicating that the disc player is qualified is displayed on the display.

10. The testing method as claimed in claim 6, wherein when the value of at least one performance parameter of the disc player is not within the corresponding reference value range of the corresponding performance parameter, a second prompt message indicating that the disc player is not qualified is displayed on the display.

11. The testing method as claimed in claim 7, wherein the type of the disc is manually input by an inputting device of the testing device.
